(19) United States
(12) Patent Application Publication
(10) Pub. No.: US 2016/0156453 A1
(43) Pub. Date: Jun. 2, 2016

(54) WIRELESS COMMUNICATION SYSTEM AND METHOD INCLUDING CO-TIME CO-FREQUENCY FULL DUPLEX COMMUNICATIONS

(71) Applicant: Institute For Information Industry, Taipei (TW)

(72) Inventors: Chun-Che CHIEN, Taipei City (TW); Shu-Tsz LIU, Taipei City (TW)

(21) Appl. No.: 14/952,977

(22) Filed: Nov. 26, 2015

Related U.S. Application Data
(60) Provisional application No. 62/085,654, filed on Dec. 1, 2014.

(51) Int. Cl. H04L 5/14; H04W 8/00; H04W 24/10; H04W 72/04; H04W 72/08

(52) U.S. Cl. CPC H04L 5/14; H04W 72/04; H04W 72/082; H04W 24/10; H04W 8/005

(57) ABSTRACT

A wireless communication system and method including co-time co-frequency full duplex (CCFD) communications are provided. The wireless communication system includes at least one user equipment and a communication device coupled with the at least one user equipment. The at least one user equipment is configured to provide at least one CCFD) measurement report. The communication device is configured to assign one of a symmetric CCFD communication mode, an asymmetric CCFD communication mode and a non-CCFD communication mode to each of the at least one user equipment. The wireless communication method includes the steps corresponding to the operations of the wireless communication system.

### PRIORITY

This application claims priority to U.S. Provisional Patent Application No. 62/085,654 filed on Dec. 1, 2014, which is incorporated herein for reference in its entirety.

### FIELD

The present invention relates to a wireless communication system and a wireless communication method. More particularly, the present invention relates to a wireless communication system and a wireless communication method including co-time co-frequency full duplex (CCFD) communications.

### BACKGROUND

How to improve the utilization ratio of the frequency spectrum has been a concerned and important issue in the field of wireless communication. In order to improve the utilization ratio of the frequency spectrum, much attention has been paid to a technology named co-time co-frequency full duplex (CCFD). The CCFD refers to the co-time and co-frequency signal transmission and reception on a single physical channel for the purpose of improving the utilization ratio of the frequency spectrum. However, since the co-time and co-frequency signal transmission and reception are performed on a single physical channel in the CCFD technology, mutual interference between transmitted signals and received signals must be prevented effectively in use of the CCFD technology. Generally, in order to implement the CCFD technology, antenna isolation, analog interference cancellation, digital interference cancellation, fundamental frequency algorithms or the like are usually used in combination to cancel or suppress the mutual interference between the transmitted signals and the received signals.

In various wireless communication systems, a user equipment (UE) may be a movable device, and the mobility of the UE may change the communication channel between the UE and a base station or other UEs. Even if the UE does not move (e.g., stays at a fixed position for a long time), the communication channel between the UE and the base station or other UEs may also change over time or due to external environmental factors (i.e., the time-varying channel). Additionally, in various wireless communication systems, with the wear of the UEs or the base station, the ability of the UEs or the base station to cancel or suppress the interference may also change. Also, in various wireless communication systems, the change of the distance between the UE and the base station may influence the mutual interference between the UE and the base station, and the change of the distance between the UEs may also influence the mutual interference between the UEs. As can be known from this, in addition to the factor of whether the UE itself can suppress the mutual interference between the signals that it transmits and receives, there are still many factors that determine whether the UE is suitable for the CCFD communication.

According to the above reasons, UEs that originally adopt the CCFD for communication might become unsuitable for the CCFD communication due to the aforesaid factors, while UEs that do not adopt the CCFD for communication originally might now become suitable for the CCFD communication due to the aforesaid factors. However, the conventional CCFD technology has not proposed an effective solution to overcome this problem yet. Accordingly, an urgent need exists in the art to assign a suitable communication mode to a UE under the architecture of CCFD.

### SUMMARY

The disclosure includes a wireless communication system including co-time co-frequency full duplex (CCFD) communications. The wireless communication system may comprise at least one user equipment (UE) and a communication device coupled with the at least one UE. The at least one UE may be configured to provide at least one CCFD measurement report. The communication device may be configured to assign one of a symmetric CCFD communication mode, an asymmetric CCFD communication mode and a non-CCFD communication mode to each of the at least one UE according to the at least one CCFD measurement report. Any of the at least one UE that corresponds to the symmetric CCFD communication mode may perform a symmetric CCFD communication with the communication device. Any two of the at least one UE that correspond to the asymmetric CCFD communication mode may perform an asymmetric CCFD communication with the communication device. Any of the at least one UE that corresponds to the non-CCFD communication mode may perform a non-CCFD communication with the communication device.

The disclosure also includes a wireless communication method including CCFD communications. The wireless communication method may comprise the following steps of: providing at least one CCFD measurement report by at least one user equipment (UE); and assigning, by a communication device, one of a symmetric CCFD communication mode, an asymmetric CCFD communication mode and a non-CCFD communication mode to each of the at least one UE according to the at least one CCFD measurement report. Any of the at least one UE that corresponds to the symmetric CCFD communication mode may perform a symmetric CCFD communication with the communication device. Any two of the at least one UE that correspond to the asymmetric CCFD communication mode may perform an asymmetric CCFD communication with the communication device. Any of the at least one UE that corresponds to the non-CCFD communication mode may perform a non-CCFD communication with the communication device.

The disclosure further includes at least one UE of a wireless communication system that may provide at least one CCFD measurement report to a communication device of the wireless communication system, and the communication device may assign a suitable communication mode to each of the at least one UE according to the at least one CCFD measurement report. Thus, the present invention can dynamically determine whether a UE is suitable for the CCFD communication and assign a suitable communication mode to the UE even in any of the following cases: the communication channel between the UE and a base station is changed, the communication channel between the UE and other UEs is changed, the ability of the UE itself to cancel or suppress the interference is changed, the mutual interference between the UE and the base station is changed, and the mutual interference between the UE and other UEs is changed or the like.

The above summary presents a summary of some aspects of the present invention (including some problems to be solved, the means to solve the problem and the effect of the present invention) to provide a basic understanding of these aspects. However, this is not intended to contemplate all aspects of the present invention. Additionally, this summary is neither intended to identify key or essential elements of any or all aspects of the present invention, nor intended to describe the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating a wireless communication system including CCFD communications according to one or more embodiments of the present invention.

FIG. 2 is a schematic view illustrating communication modes between a communication device and UEs as shown in FIG. 1 according to one or more embodiments of the present invention.

FIG. 3A is a schematic view illustrating a kind of source assignment according to one or more embodiments of the present invention.

FIG. 3B is a schematic view illustrating another kind of source assignment according to one or more embodiments of the present invention.

FIG. 4 is a schematic view illustrating an overall operation of the wireless communication system of FIG. 1 according to one or more embodiments of the present invention.

FIG. 5A to FIG. 5B are schematic views illustrating how to choose from UEs that correspond to the asymmetric CCFD communication mode according to one or more embodiments of the present invention.

FIG. 6A to FIG. 6E illustrate various application scenarios of the wireless communication system of FIG. 1 according to one or more embodiments of the present invention.

FIG. 7 is a flowchart diagram of a wireless communication method including CCFD communications according to one or more embodiments of the present invention.

### DETAILED DESCRIPTION

In the following description, the present invention will be further explained with reference to example embodiments thereof. However, these example embodiments are not intended to limit the present invention to any specific examples, embodiments, environment, applications, structures, processes or steps described in these example embodiments. In the attached drawings, elements unrelated to the present invention are omitted from depiction. In addition, dimensional relationships among individual elements in the attached drawings are illustrated only for ease of describing the present invention, but not to limit the actual scale. In the following descriptions, the same reference numeral corresponds to the same element unless otherwise stated.

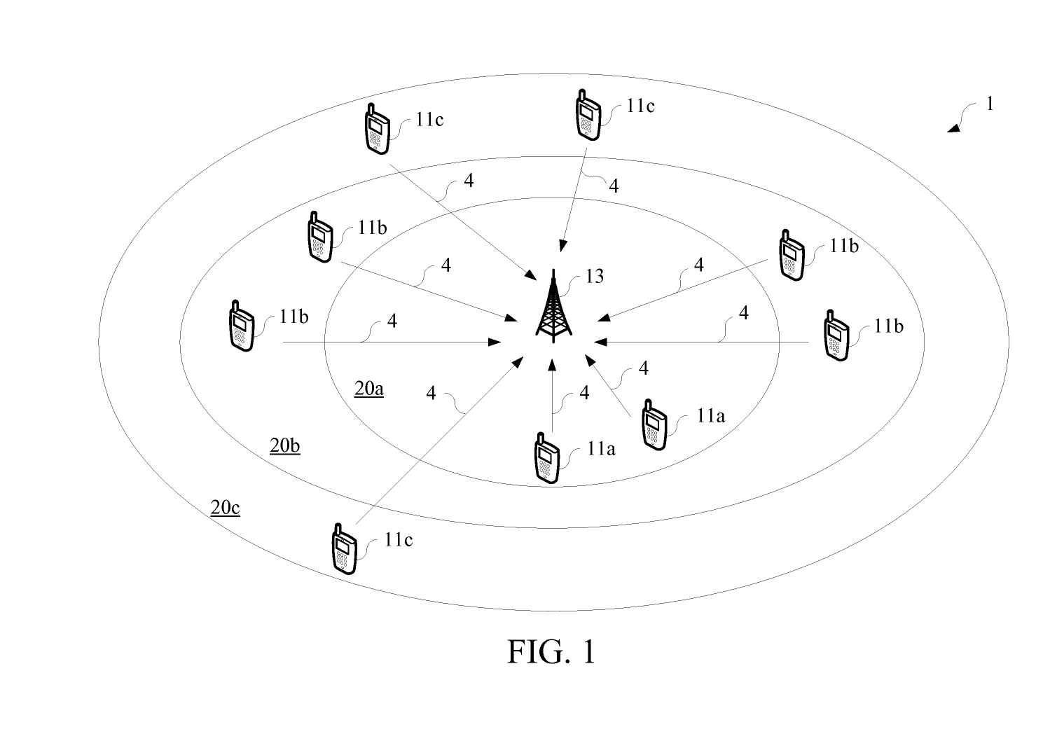

An embodiment (called “a first embodiment” hereinafter) of the present invention is a wireless communication system including CCFD communications. FIG. 1 is a schematic view illustrating a wireless communication system including CCFD communications according to one or more embodiments of the present invention. For ease of description other than for purpose of limitation, as shown in FIG. 1, the wireless communication system 1 comprises a plurality of UEs 11a, 11b and 11c (i.e., two UEs 11a, four UEs 11b and three UEs 11c) and a communication device 13 coupled with the UEs 11a, 11b and 11c. In other words, the wireless communication system of this embodiment essentially comprises at least one UE (i.e., one or more UEs) and at least one communication device (i.e., one or more communication devices).

The wireless communication system 1 may be established on various conventional wireless communication systems and comprise the basic architecture of the conventional wireless communication systems. The conventional wireless communication systems may for example be but are not limited to: LTE, LTE-advanced, a Universal Mobile Telecommunications System (UMTS), a Global System for Mobile Communications (GSM) or the like.

Each of the UEs 11a, 11b and 11c may be any of various types of electronic devices, for example but not limited to: tablet computers, notebook computers, intelligent mobile phones, digital cameras or the like. The communication device 13 may be one of a base station and a UE. Thus, the communication device 13 may be any of various types of base stations, for example but not limited to: macrocells, microcells, picocells or the like. Additionally, the communication device 13 may also be any of various types of electronic devices, for example but not limited to: tablet computers, notebook computers, intelligent mobile phones or the like. When the communication device 13 is a base station, the communications between the communication device 13 and the UEs 11a, 11b and 11c may be performed via various base station-UE communication technologies. When the communication device 13 is a UE, the communications between the communication device 13 and the UEs 11a, 11b and 11c may be performed via various device-to-device (D2D) communication technologies.

Each of the UEs 11a, 11b and 11c may comprise at least one transceiver (not shown) to be coupled with other UEs or coupled with the communication device 13 for transmitting and receiving various signals and/or data. Similarly, the communication device 13 may comprise at least one transceiver (not shown) to be coupled with each of the UEs 11a, 11b and 11c for transmitting and receiving various signals and/or data. The UEs 11a, 11b and 11c and the communication device 13 may each comprise a computer-related device. The computer-related device may comprise a computing component such as a general-purpose processor or microprocessor, and execute various computations by use of this computing component. The computer-related device may comprise a storage component such as a general-purpose memory and/or storage, and store various data in this storage component. The computer-related device may comprise general-purpose input/output components, and receive incoming data and transmit outgoing data via the input/output components. The computer-related device may execute corresponding operations described below via the computing component, the storage component, the input/output components or the like according to processes implemented by software, firmware, programs, algorithms or the like. The operations described with respect to the UEs 11a, 11b and 11c and the communication device 13 can all be implemented via the computer-related device and the transceiver comprised in each of the UEs 11a, 11b and 11c and the communication device 13 unless otherwise stated.

Referring to FIG. 1, it is assumed that three regions (i.e., regions 20a, 20b and 20c) are defined with the communication device 13 as a center depending on the distances from the regions to the center, and the UEs 11a are located within the region 20a, the UEs 11b are located within the region 20b, and the UEs 11c are located within the region 20c. The quantity and the positions of the UEs 11a, 11b and 11c and the communication device 13 in FIG. 1 are only exemplary and not intended to limit the present invention. In the wireless communication system 1, each of the UEs 11a, 11b and 11c may provide a CCFD measurement report 4 to the communication device 13. In other embodiments, it is not necessary for each of the UEs 11a, 11b and 11c to provide the CCFD measurement report 4 to the communication device 13. For example, one or a part of a plurality of UEs that are close in distance may provide the CCFD measurement report 4 to the communication device 13. Alternatively, one or more particular UEs may summarize the CCFD measurement reports 4 provided by other UEs in advance and then provide the summarized CCFD measurement reports 4 to the communication device 13.

The CCFD measurement report 4 may comprise various pieces of information about or influencing whether the UE is suitable for the CCFD communication, for example but not limited to: location information of each of the UEs 11a, 11b and 11c, traffic information of each of the UEs 11a, 11b and 11c, uplink and downlink requirement information of each of the UEs 11a, 11b and 11c, self-interference information of each of the UEs 11a, 11b and 11c, and mutual-interference information between the UEs 11a, 11b and 11c or the like.

As compared to the UE(s) that is far away from the communication device 13, the UE(s) that is closer to the communication device 13 can transmit signals to the communication device 13 with a lower strength so as to reduce the interference to the signals received by the UE itself from the signals transmitted by the UE itself. Thus, according to the location information of each of the UEs 11a, 11b and 11c, the communication device 13 may determine that the UE 11a is most suitable for the CCFD communication, the UE 11b is less suitable for the CCFD communication, and the UE 11c is least suitable for the CCFD communication.

As compared to the UE of which the uplink traffic and the downlink traffic are asymmetric, the UE of which the uplink traffic and the downlink traffic are symmetric has a higher utilization ratio for the frequency spectrum. Thus, according to the traffic information of each of the UEs 11a, 11b and 11c, the communication device 13 may determine that the UE of which the uplink traffic and the downlink traffic are symmetric is more suitable for the CCFD communication than the UE of which the uplink traffic and the downlink traffic are asymmetric.

As compared to the UE(s) that is less capable of cancelling or suppressing the self-interference, the UE(s) that is more capable of cancelling or suppressing the self-interference can reduce the interference to the signals received by the UE itself from the signals transmitted by the UE itself. Thus, according to the self-interference information of each of the UEs 11a, 11b and 11c, the communication device 13 may determine that the UE that is more capable of cancelling or suppressing the self-interference is more suitable for the CCFD communication than the UE that is less capable of cancelling or suppressing the self-interference.

As compared to the UE(s) that is vulnerable to the interference from other UEs, the UE(s) that is less vulnerable to the interference from other UEs can reduce the interference to the signals received by the UE itself from the signals transmitted by other UEs. Thus, according to the mutual-interference information between the UEs 11a, 11b and 11c, the communication device 13 may determine that the UE that is less vulnerable to the interference from other UEs is more suitable for the CCFD communication than the UE that is vulnerable to the interference from other UEs.

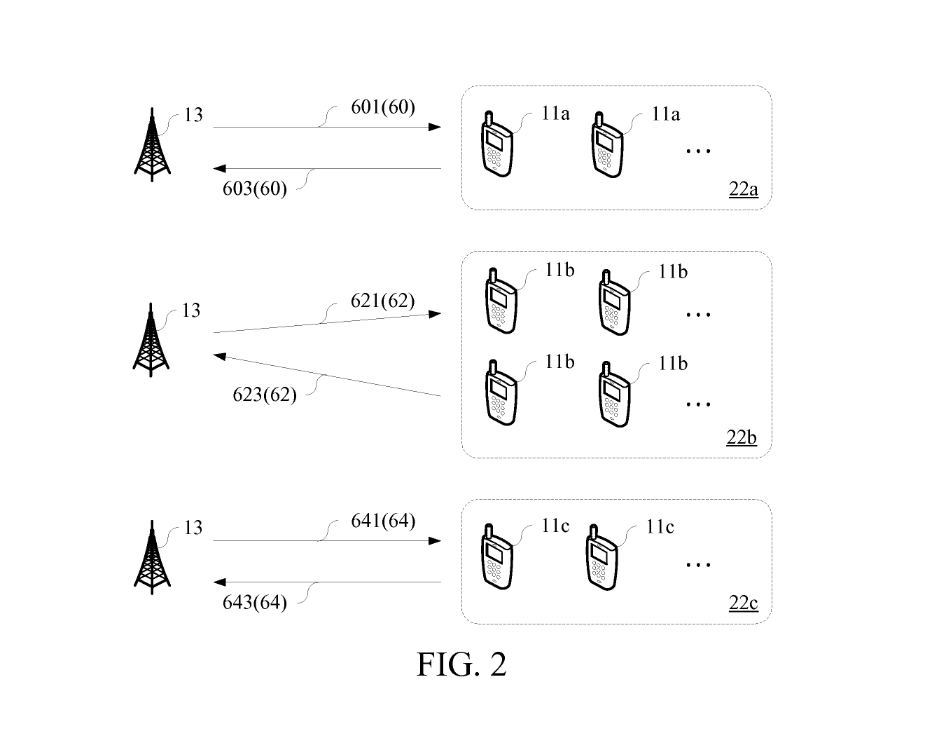

FIG. 2 is a schematic view illustrating communication modes between the communication device 13 of FIG. 1 and the UEs 11a, 11b and 11c according to one or more embodiments of the present invention. Referring to FIG. 1 and FIG. 2, after receiving the CCFD measurement reports 4 provided from the UEs 11a, 11b and 11c, the communication device 13 may assign one of a symmetric CCFD communication mode 22a, an asymmetric CCFD communication mode 22b and a non-CCFD communication mode 22c to each of the UEs 11a, 11b and 11c according to the CCFD measurement reports 4. In this embodiment, it is assumed that the communication device 13 assigns the symmetric CCFD communication mode 22a to two UEs 11a, assigns the asymmetric CCFD communication mode 22b to four UEs 11b, and assigns the non-CCFD communication mode 22c to three UEs 11c. In other words, two UEs 11a correspond to the symmetric CCFD communication mode 22a, four UEs 11b correspond to the asymmetric CCFD communication mode 22b, and three UEs 11c correspond to the non-CCFD communication mode 22c.

After the communication device 13 has assigned a communication mode to each of the UEs 11a, 11b and 11c, each of the UEs 11a, 11b and 11c will perform communication according to the assigned communication mode. Specifically, any of the UEs 11a that corresponds to the symmetric CCFD communication mode 22a may perform a symmetric CCFD communication 60 with the communication device 13. The symmetric CCFD communication 60 comprises a downlink communication 601 and an uplink communication 603. The symmetric CCFD communication 60 means that the downlink communication 601 and the uplink communication 603 are performed in a co-time and co-frequency way between the communication device 13 and a single UE 11a. In other words, both the communication device 13 and any of the UEs 11a adopt the CCFD, so co-time and co-frequency signal transmission and reception can be performed between the communication device 13 and a single UE 11a.

At least any two of the UEs 11b that correspond to the asymmetric CCFD communication mode 22b may perform an asymmetric CCFD communication 62 with the communication device 13. The asymmetric CCFD communication 62 comprises a downlink communication 621 and an uplink communication 623. The asymmetric CCFD communication 62 means that the downlink communication 621 and the uplink communication 623 are performed in a co-time and co-frequency way between the communication device 13 and the at least two UEs 11b. In other words, only the communication device 13 adopts the CCFD and neither of the UEs 11b adopts the CCFD, so co-time and co-frequency signal transmission and reception cannot be performed between the communication device 13 and a single UE 11b; however, the communication device 13 may transmit signals to any of the UEs 11b while receiving signals from another UE 11b in a same frequency band.

Any of the UEs 11c that corresponds to the non-CCFD communication mode 22c may perform a non-CCFD communication 64 with the communication device 13. The non-CCFD communication 64 comprises a downlink communication 641 and an uplink communication 643. The non-CCFD communication 64 means that the downlink communication 641 and the uplink communication 643 are performed in a non co-time and co-frequency way between the communication device 13 and any of the UEs 11c. In other words, neither the communication device 13 nor any of the UEs 11c adopts the CCFD, so co-time and co-frequency signal transmission and reception cannot be performed either between the communication device 13 and a single UE 11c or between the communication device 13 and a plurality of UEs 11c.

After assigning a communication mode to each of the UEs 11a, 11b and 11c, the communication device 13 may further assign resources to the symmetric CCFD communication mode 22a, the asymmetric CCFD communication mode 22b and the non-CCFD communication mode 22c according to various multiplexing technologies. The multiplexing technologies may for example be but are not limited to: a frequency-division multiplexing (FDM) technology and a time-division multiplexing (TDM) technology. Assigning resources by adopting the FDM technology means that the resources are assigned to different communication modes through different frequency bands, and assigning resources by adopting the TDM technology means that the resources are assigned to different communication modes through different time periods.

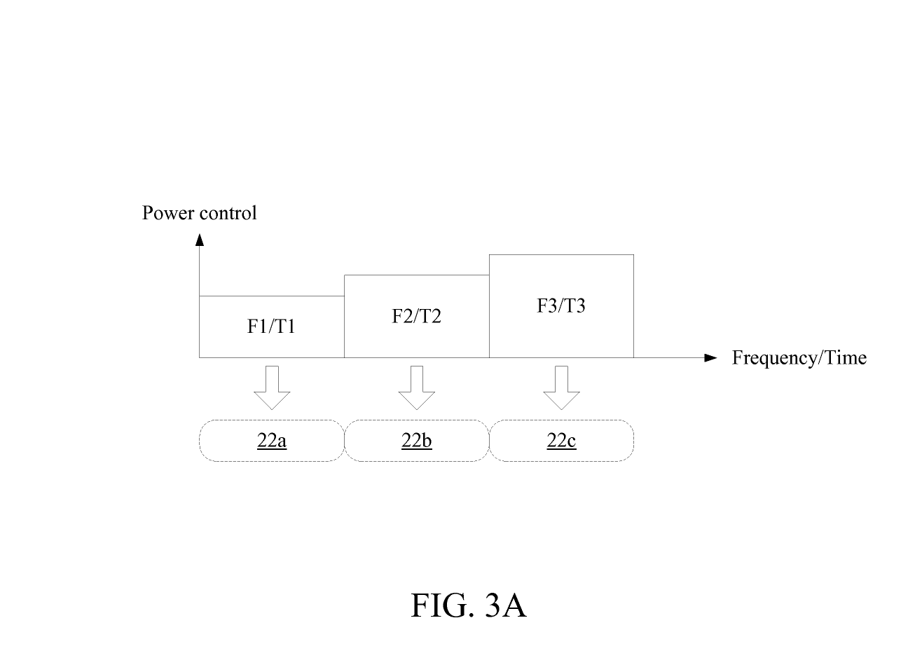

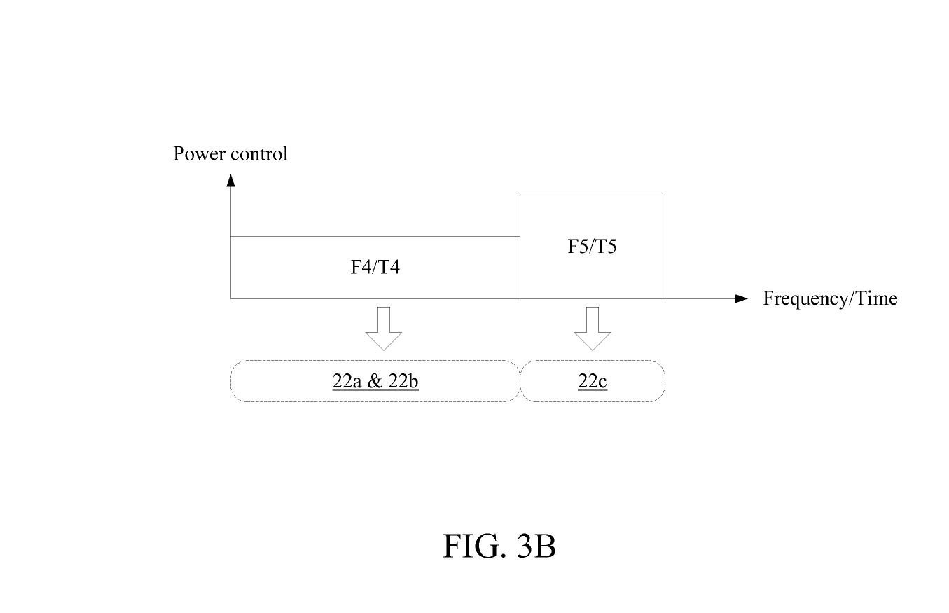

FIG. 3A is a schematic view illustrating a kind of source assignment according to one or more embodiments of the present invention. Referring to FIG. 3A, the communication device 13 may assign resources to the symmetric CCFD communication mode 22a, the asymmetric CCFD communication mode 22b and the non-CCFD communication mode 22c according to the FDM technology or the TDM technology. The resource assigned to the symmetric CCFD communication mode 22a corresponds to a frequency band F1 (or a time period T1), the resource assigned to the asymmetric CCFD communication mode 22b corresponds to a frequency band F2 (or a time period T2), and the resource assigned to the non-CCFD communication mode 22c corresponds to a frequency band F3 (or a time period T3). Preferably, the power at the frequency band F1 (or the time period T1) is the lowest, the power at the frequency band F2 (or the time period T2) is higher, and the power at the frequency band F3 (or the time period T3) is the highest; however, this is not intended to be limiting. In other words, the power at the frequency band F1 (or the time period T1), the frequency band F2 (or the time period T2) and the frequency band F3 (or the time period T3) may be adjusted in response to different situations.

FIG. 3B is a schematic view illustrating another kind of source assignment according to one or more embodiments of the present invention. Referring to FIG. 3B, the communication device 13 may assign resources to the symmetric CCFD communication mode 22a, the asymmetric CCFD communication mode 22b and the non-CCFD communication mode 22c according to the FDM technology or the TDM technology. The resource assigned to the symmetric CCFD communication mode 22a corresponds to a frequency band F4 (or a time period T4), the resource assigned to the asymmetric CCFD communication mode 22b also corresponds to the frequency band F4 (or the time period T4), and the resource assigned to the non-CCFD communication mode 22c corresponds to a frequency band F5 (or a time period T5). Preferably, the power at the frequency band F4 (or the time period T4) is lower than the power at the frequency band F5 (or the time period T5), however, this is not intended to be limiting. In other words, the power at the frequency band F4 (or the time period T4) and the frequency band F5 (or the time period T5) may be adjusted in response to different situations.

The communication device 13 may assign a communication mode to each of the UEs 11a, 11b and 11c and/or assign resources to different communication modes via various channels. Taking the specification of the LTE as an example, the various channels may for example be but are not limited to: a physical downlink control channel (PDCCH), a physical downlink shared channel (PDSCH) or the like. Each of the UEs 11a, 11b and 11c may transmit the CCFD measurement report 4 or other measurement and evaluation reports to the communication device 13 via various channels. Taking the specification of the LTE as an example, the various channels may for example be but are not limited to: a physical uplink control channel (PUCCH), a physical uplink shared channel (PUSCH) or the like. The communication device 13 may estimate the distance from the communication device 13 to each of the UEs 11a, 11b and 11c in various ways, for example but not limited to, a sounding reference signal (SRS) technology.

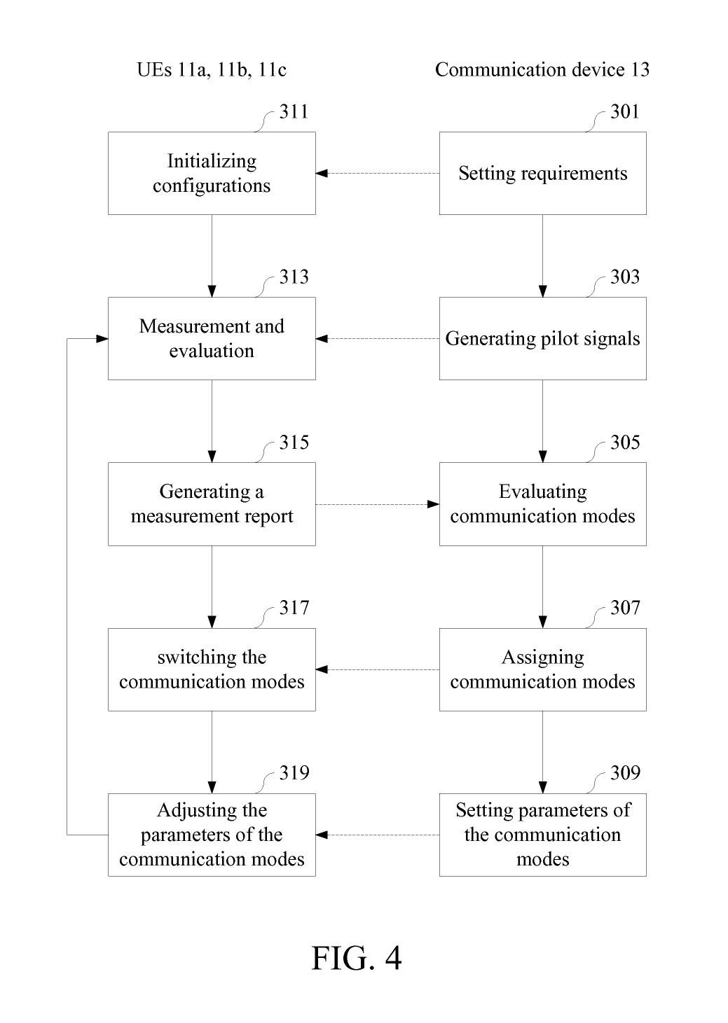

The overall operation of the wireless communication system 1 will be described hereinafter by taking FIG. 4 as an exemplary example, but the exemplary example is not intended to be limiting. As shown in FIG. 4, after the communication device 13 sets the requirements for CCFD communication (labeled as 301), the UEs 11a, 11b and 11c may be informed to initialize various configurations (labeled as 311). Then, the communication device 13 may generate pilot signals related to the CCFD communication (labeled as 303), and transmit the pilot signals to the UEs 11a, 11b and 11c. The UEs may perform various kinds of measurement and evaluation related to the CCFD communication according to the pilot signals (labeled as 313). Items to be measured and evaluated may for example be but are not limited to: location information of each of the UEs 11a, 11b and 11c, traffic information of each of the UEs 11a, 11b and 11c, self-interference information of each of the UEs 11a, 11b and 11c, and mutual-interference information between the UEs 11a, 11b and 11c, or the like. Additionally, each of the UEs 11a, 11b and 11c may further evaluate whether it is capable of performing the CCFD communication.

After performing the measurement and evaluation related to the CCFD communication, the UEs 11a, 11b and 11c may generate a measurement report related to the CCFD communication (i.e., the CCFD measurement report 4 described above) (labeled as 315), and provide the measurement report to the communication device 13. The communication device 13 may evaluate the communication modes of the UEs 11a, 11b and 11c according to the measurement report (labeled as 305).

After evaluating the communication modes of the UEs 11a, 11b and 11c, the communication device 13 may assign a communication mode to each of the UEs 11a, 11b and 11c (labeled as 307). For example, the communication device 13 may assign one of a symmetric CCFD communication mode 22a, an asymmetric CCFD communication mode 22b and a non-CCFD communication mode 22c to each of the UEs 11a, 11b and 11c. After assigning the communication modes to the UEs 11a, 11b and 11c, the communication device 13 may set various parameters required by each communication mode (including the aforesaid resource assignments) and transmit the parameters to the UEs 11a, 11b and 11c (labeled as 309).

On the other hand, after the communication modes are assigned to the UEs 11a, 11b and 11c, the UEs 11a, 11b and 11c may switch the communication modes (labeled as 317). Thereafter, according to the various parameters required by the communication modes that are set by the communication device 13, the UEs 11a, 11b and 11c may correspondingly adjust the various parameters required by the communication modes (labeled as 319). If the UEs are suitable for communications after the parameters are adjusted, then the UEs 11a, 11b and 11c may perform communications with the corresponding communication modes. For example, any of the UEs 11a that corresponds to the symmetric CCFD communication mode 22a may perform a symmetric CCFD communication 60 with the communication device 13; any two of the UEs 11b that correspond to the asymmetric CCFD communication mode 22b may perform an asymmetric CCFD communication 62 with the communication device 13; and any of the UEs 11c that corresponds to the non-CCFD communication mode 22c may perform a non-CCFD communication 64 with the communication device 13. Optionally, if the UEs are unsuitable for communications due to the change of the channel caused by the movement after the parameters are adjusted, then various kinds of measurement and evaluation related to the CCFD communication may be performed again (labeled as 313).

Optionally, the communication device 13 may assign one of an asymmetric CCFD downlink communication mode 30 and an asymmetric CCFD uplink communication mode 32 to each of the UEs 11b corresponding to the asymmetric CCFD communication mode 22b during a time interval according to the CCFD measurement report 4. Then, the communication device 13 may choose at least one downlink UE b1 from the UEs 11b corresponding to the asymmetric CCFD downlink communication mode 30 and choose at least one uplink UE b2 from the UEs 11b corresponding to the asymmetric CCFD uplink communication mode 32 for each of the asymmetric CCFD communications 62 to satisfy a communication requirement during the time interval. After the time interval, the communication device 13 may assign the asymmetric CCFD uplink communication mode 32 to the UE 11b corresponding to the asymmetric CCFD downlink communication mode 30, and may assign the asymmetric CCFD downlink communication mode 30 to the UE 11b corresponding to the asymmetric CCFD uplink communication mode 32.

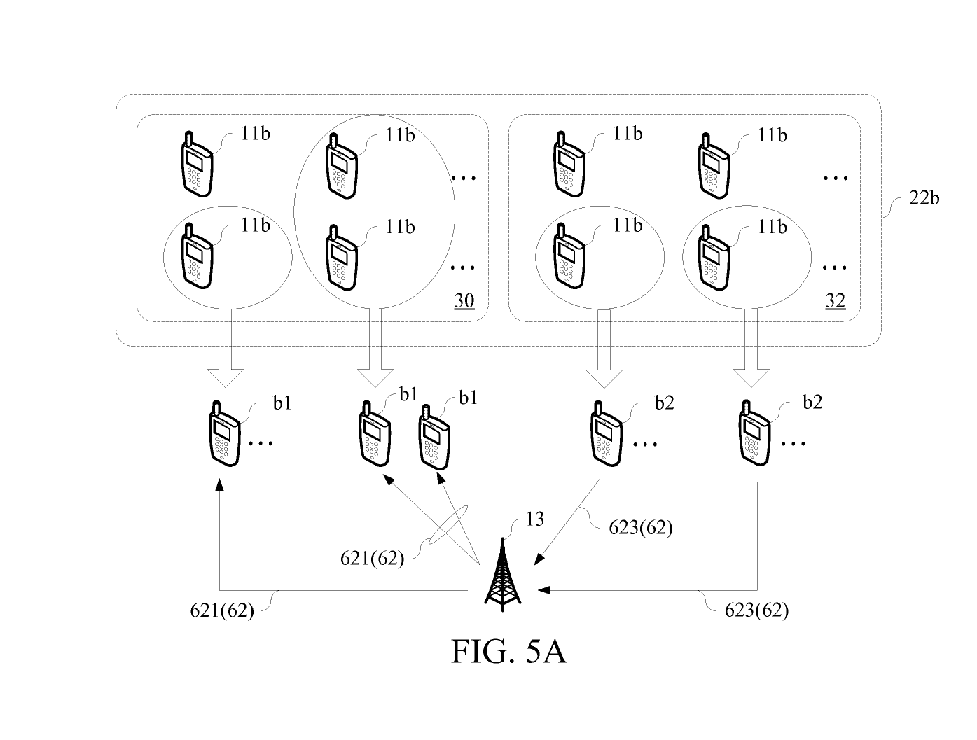

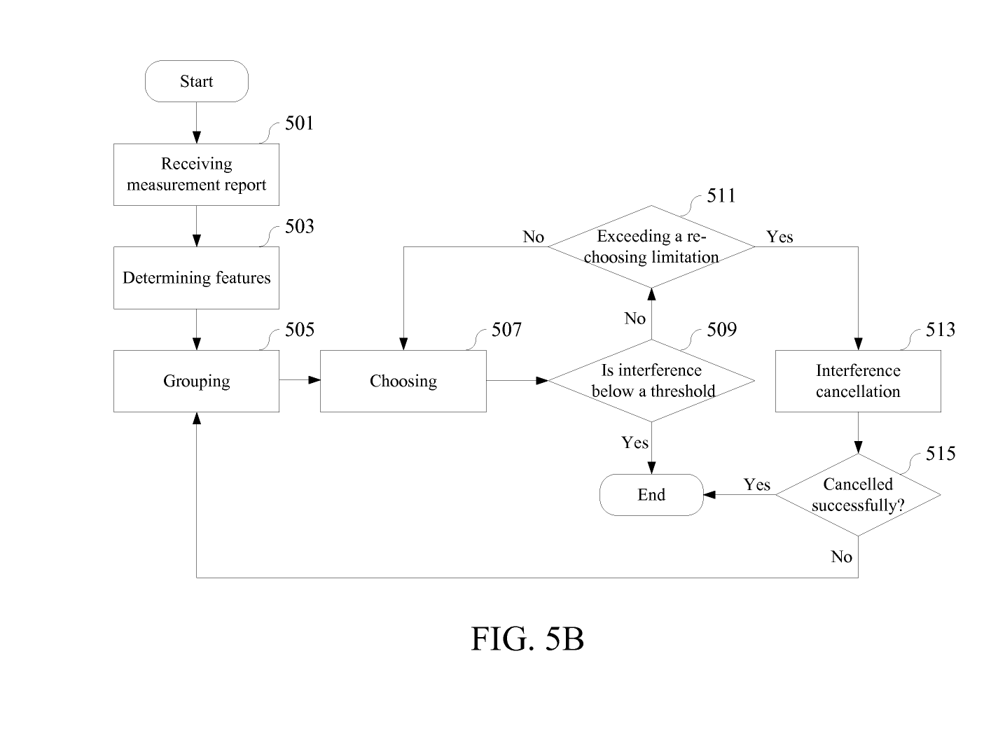

The method in which the communication device 13 chooses from UEs 11b corresponding to the asymmetric CCFD communication mode 22b will be described hereinafter by taking FIG. 5A to FIG. 5B as exemplary examples, but the exemplary examples are not intended to be limiting. FIG. 5A to FIG. 5B are schematic views illustrating how to choose from UEs that correspond to the asymmetric CCFD communication mode according to one or more embodiments of the present invention. Referring to FIG. 5A to FIG. 5B, after receiving the CCFD measurement report 4 provided from the UEs 11b (labeled as 501), the communication device 13 may determine various features of the UEs 11b according to the CCFD measurement report 4 (labeled as 503). The CCFD measurement report 4 may comprise location information, uplink and downlink requirement information, and traffic information of each of the UEs 11b corresponding to the asymmetric CCFD communication mode 22b, and mutual-interference information between the UEs 11b, and the features may be associated with the aforesaid information.

According to the various features of the UEs 11b, the communication device 13 may divide the UEs 11b into groups within a time interval (labeled as 505). In other words, the communication device 13 may divide the UEs 11b corresponding to the asymmetric CCFD communication mode 22b into two groups, i.e., the asymmetric CCFD downlink communication mode 30 and the asymmetric CCFD uplink communication mode 32. For example (but not for limitation), the communication device 13 may assign the asymmetric CCFD downlink communication mode 30 to the UEs 11b within a particular region and assign the asymmetric CCFD uplink communication mode 32 to the UEs 11b within another particular region different from the particular region according to the position information of the UEs 11b.

After dividing the UEs 11b into groups, the communication device 13 may decide the number of members in each of the groups, and the communication device 13 chooses at least one downlink UE b1 (i.e., chooses one or more downlink UEs b1) from the UEs 11b corresponding to the asymmetric CCFD downlink communication mode 30 and chooses at least one uplink UE b2 (i.e., chooses one or more uplink UEs b2) from the UEs 11b corresponding to the asymmetric CCFD uplink communication mode 32 for each of the asymmetric CCFD communications 62 to be performed to satisfy a communication requirement during the time interval (labeled as 507). In this embodiment, the communication requirement is associated with at least one of traffic symmetry and mutual-interference level. Therefore, for each of the asymmetric CCFD communications 62 to be performed, the communication device 13 may choose respectively from the UEs 11b corresponding to the asymmetric CCFD downlink communication mode 30 and the UEs 11b corresponding to the asymmetric CCFD uplink communication mode 32 during the time interval according to (any one or both of) the traffic symmetry and the mutual-interference level. In other embodiments, the communication device 13 may also choose depending on different requirements.

For example, in order to make the traffic required by the downlink communication 621 symmetric to (may be same as or similar to) the traffic required by the uplink communication 623, the communication device 13 may choose in the following way: if the traffic of a single downlink UE b1 is the same as or similar to the traffic of a single uplink UE b2, then the communication device 13 chooses the single downlink UE b1 from the UEs 11b corresponding to the asymmetric CCFD downlink communication mode 30 and chooses the single uplink UE b2 from the UEs 11b corresponding to the asymmetric CCFD uplink communication mode 32; if the traffic of a single downlink UE b1 is the same as or similar to the total traffic of a plurality of uplink UEs b2, then the communication device 13 chooses the single downlink UE b1 from the UEs 11b corresponding to the asymmetric CCFD downlink communication mode 30 and chooses the plurality of uplink UEs b2 from the UEs 11b corresponding to the asymmetric CCFD uplink communication mode 32; and if the total traffic of a plurality of downlink UEs b1 is the same as or similar to the traffic of a single uplink UE b2, then the communication device 13 chooses the plurality of downlink UEs b1 from the UEs 11b corresponding to the asymmetric CCFD downlink communication mode 30 and chooses the single uplink UE b2 from the UEs 11b corresponding to the asymmetric CCFD uplink communication mode 32.

As another example, the communication device 13 may choose at least one downlink UE b1 from the UEs 11b corresponding to the asymmetric CCFD downlink communication mode 30 and choose at least one uplink UE b2 from the UEs 11b corresponding to the asymmetric CCFD uplink communication mode 32 according to the mutual interference between the UEs 11b corresponding to the asymmetric CCFD communication mode 22b.

After at least one downlink UE b1 and at least one uplink UE b2 are chosen, the communication device 13 may further determine whether the mutual interference between the chosen downlink UE b1 and the uplink UE b2 is below a threshold (e.g., an allowable interference threshold). If the determination result is “yes”, then the communication device 13 may perform the asymmetric CCFD communications 62 with the chosen downlink UE b1 and the uplink UE b2. If the determination result is “no”, then the communication device 13 may determine whether a preset number of times of re-choosing is exceeded (labeled as 511). If the preset number of times of re-choosing is not exceeded, then the communication device 13 may re-choose at least one downlink UE b1 from the UEs 11b corresponding to the asymmetric CCFD downlink communication mode 30 and re-choose at least one uplink UE b2 from the UEs 11b corresponding to the asymmetric CCFD uplink communication mode 32 (labeled as 507).

If the preset number of times of re-choosing is exceeded, then various kinds of interference cancellation may be performed optionally (labeled as 513), and next it is optionally determined whether the interference to the chosen downlink UE b1 and the uplink UE b2 can be cancelled successfully (labeled as 515). The items labeled as 513 and 515 are optional items rather than necessary items. The interference cancellation may for example be but is not limited to: a successive interference cancellation (SIC) technology, a network-coding based interference cancellation technology, an eNB assisted interference cancellation technology, antenna isolation, analog interference cancellation, digital interference cancellation, fundamental frequency algorithms or the like. If the interference to the chosen downlink UE b1 and the uplink UE b2 can be cancelled successfully, then the communication device 13 may perform the asymmetric CCFD communications 62 with the chosen downlink UE b1 and the uplink UE b2. If the interference to the chosen downlink UE b1 and the uplink UE b2 cannot be cancelled successfully (which may be interpreted as that the aforesaid communication requirement cannot be satisfied), then the UEs 11b may be re-divided into groups and/or the number of members in each of the groups may be re-decided (labeled as 505).

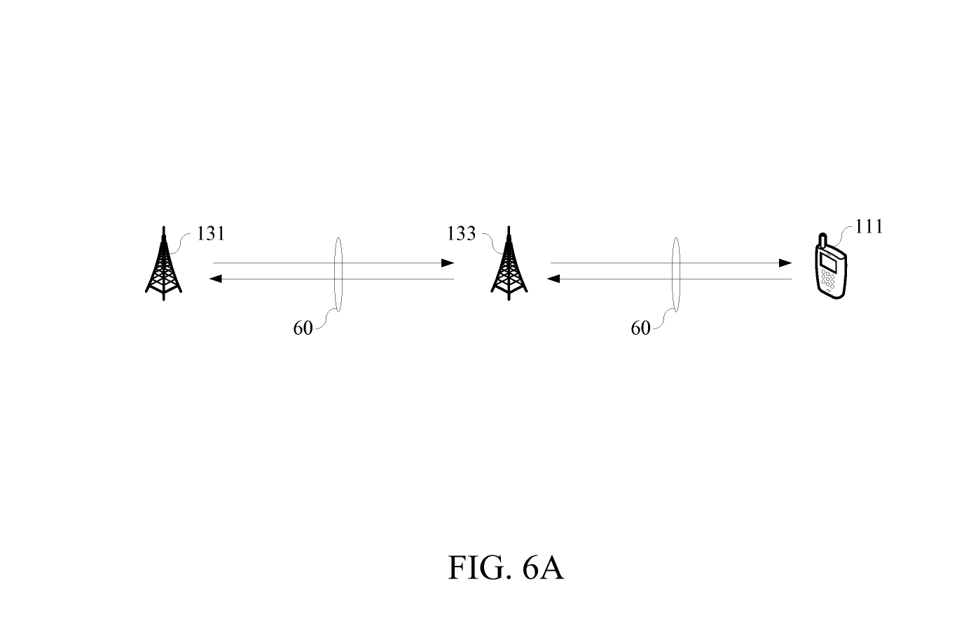

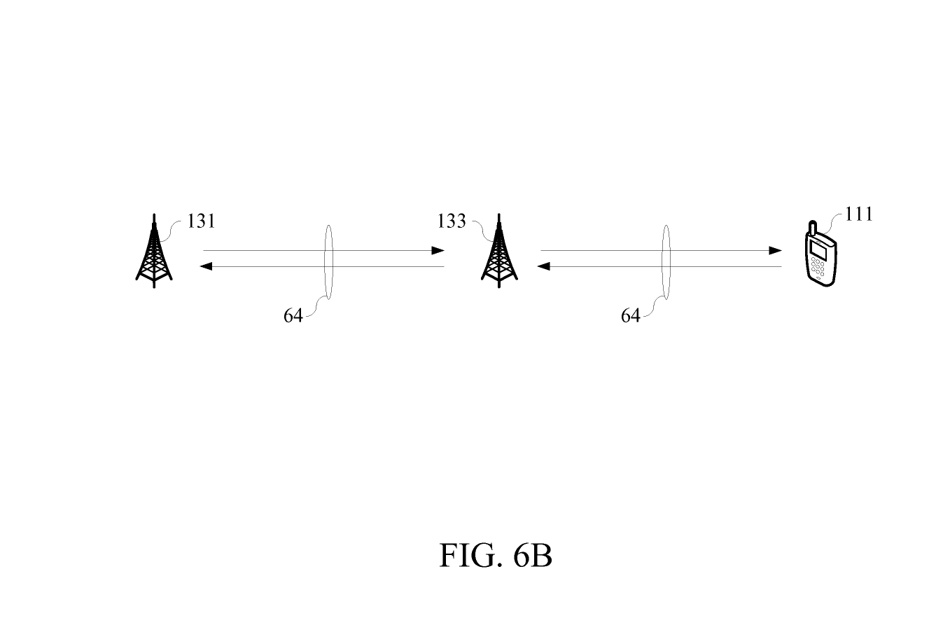

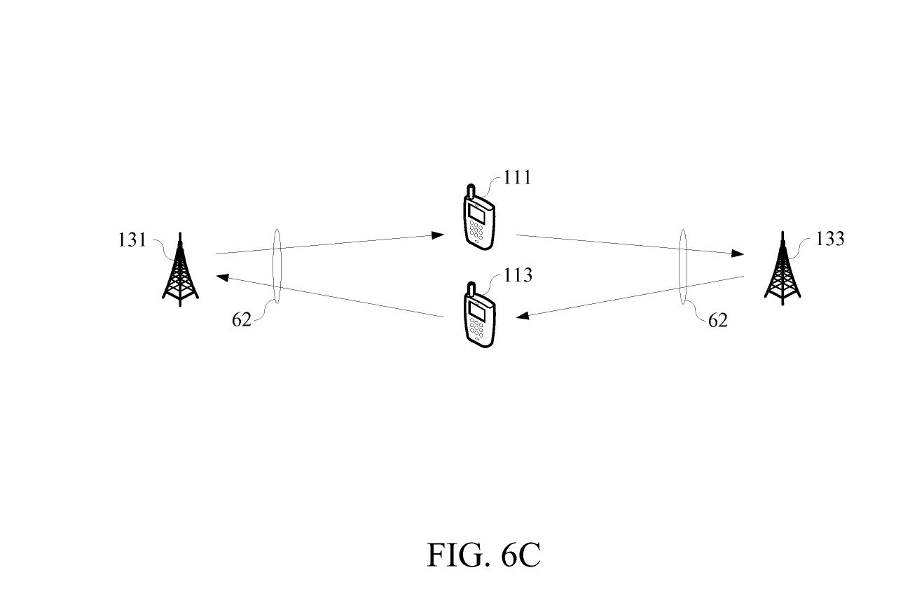

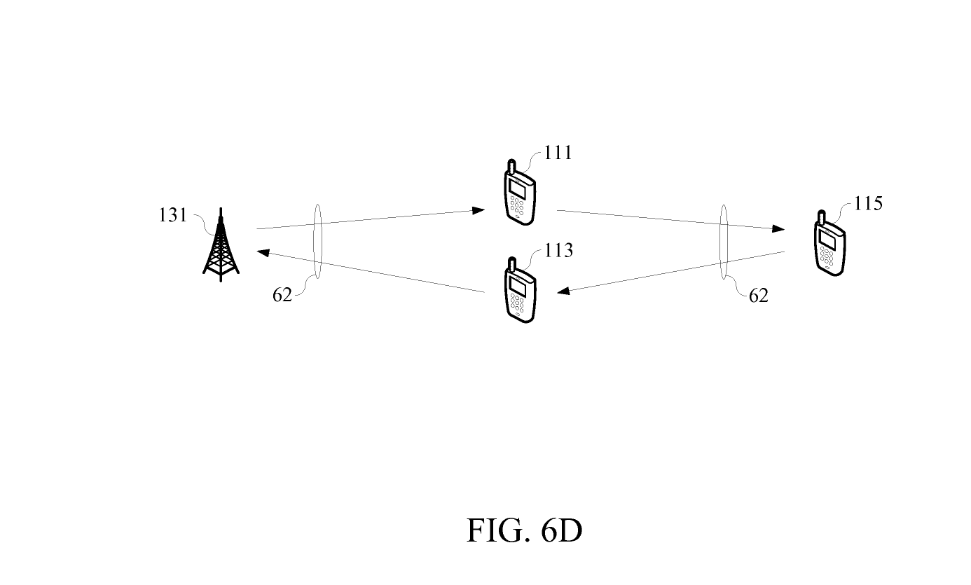

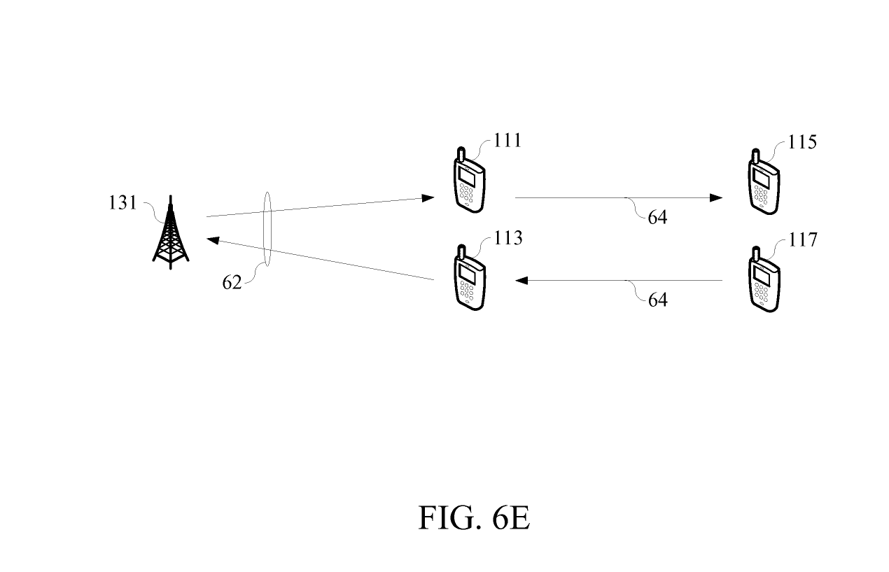

The wireless communication system 1 is applicable to various scenarios. Various application scenarios of the wireless communication system 1 will be described hereinafter by taking FIG. 6A to FIG. 6E as exemplary examples, but these exemplary examples are not intended to be limiting. FIG. 6A to FIG. 6E illustrate various application scenarios of the wireless communication system of FIG. 1 according to one or more embodiments of the present invention.

Referring to FIG. 6A, the wireless communication system 1 may comprise a communication device 131, a communication device 133 and a UE 111. The communication device 133 is a relay device, and the communication device 131 communicates with the UE 111 via the communication device 133. The UE 111 may provide the CCFD measurement report 4 to the communication device 131 and/or the communication device 133, and the communication device 131 and/or the communication device 133 may assign a suitable communication mode to the UE 111 according to the CCFD measurement report 4. As shown in FIG. 6A, the communication device 131 may perform a symmetric CCFD communication 60 with the UE 111 via the communication device 133.

Referring to FIG. 6B, the wireless communication system 1 may comprise a communication device 131, a communication device 133 and a UE 111. The communication device 133 is a relay device, and the communication device 131 communicates with the UE 111 via the communication device 133. The UE 111 may provide the CCFD measurement report 4 to the communication device 131 and/or the communication device 133, and the communication device 131 and/or the communication device 133 may assign a suitable communication mode to the UE 111 according to the CCFD measurement report 4. As shown in FIG. 6B, the communication device 131 may perform a non-CCFD communication 64 with the UE 111 via the communication device 133.

Referring to FIG. 6C, the wireless communication system 1 may comprise a communication device 131, a communication device 133, a UE 111 and a UE 113. The UE 111 and the UE 113 may provide the CCFD measurement reports 4 to the communication device 131 and the communication device 133, and the communication device 131 and the communication device 133 may assign suitable communication modes to the UE 111 and the UE 113. As shown in FIG. 6C, the communication device 131 may perform an asymmetric CCFD communication 62 with the UE 111 and the UE 113, and the communication device 133 may also perform an asymmetric CCFD communication 62 with the UE 111 and the UE 113.

Referring to FIG. 6D, the wireless communication system 1 may comprise a communication device 131, a UE 111, a UE 113 and a UE 115. The UE 111, the UE 113 and the UE 115 may provide the CCFD measurement reports 4 to the communication device 131, and the communication device 131 may assign suitable communication modes to the UE 111, the UE 113 and the UE 115. As shown in FIG. 6D, the communication device 131 may perform an asymmetric CCFD communication 62 with the UE 111 and the UE 113, and the UE 115 may also perform an asymmetric CCFD communication 62 with the UE 111 and the UE 113 (based on the D2D communication technology).

Referring to FIG. 6E, the wireless communication system 1 may comprise a communication device 131, a UE 111, a UE 113, a UE 115 and a UE 117. The UE 111, the UE 113, the UE 115 and the UE 117 may provide the CCFD measurement reports 4 to the communication device 131, and the communication device 131 may assign suitable communication modes to the UE 111, the UE 113, the UE 115 and the UE 117. The communication device 131 may perform an asymmetric CCFD communication 62 with the UE 111 and the UE 113, the UE 111 may perform a non-CCFD communication 64 with the UE 115 (based on the D2D communication technology), and the UE 113 may perform a non-CCFD communication 64 with the UE 117 (based on the D2D communication technology).

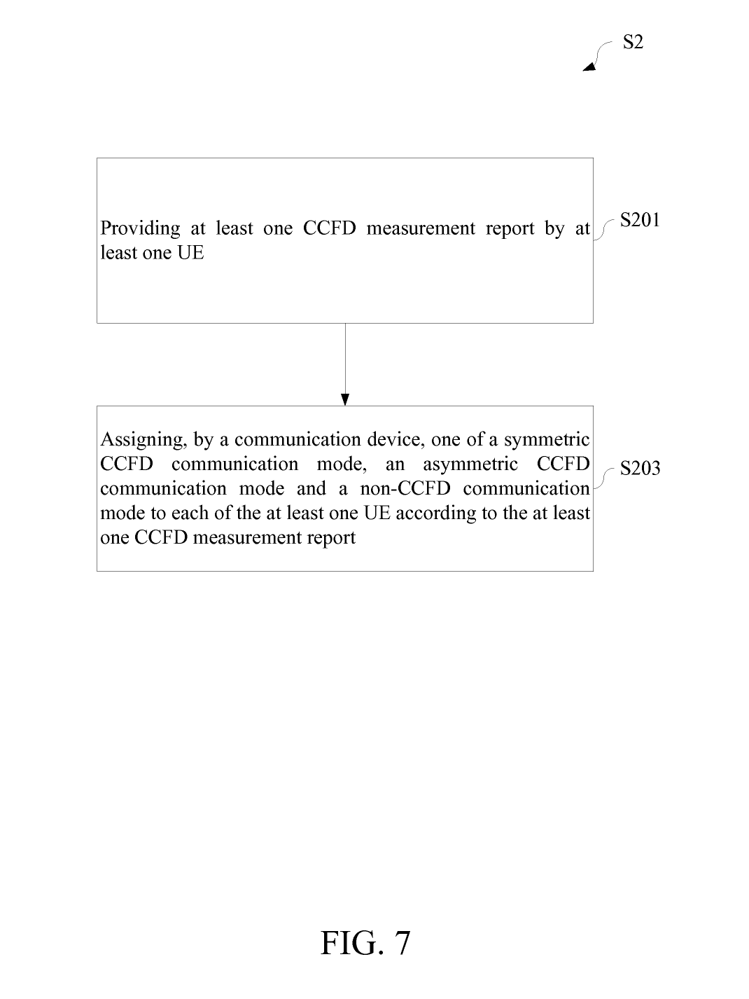

Another embodiment (called “a second embodiment” hereinafter) of the present invention is a wireless communication method including CCFD communications. FIG. 7 is a flowchart diagram of a wireless communication method including CCFD communications according to one or more embodiments of the present invention. The order in which all steps provided for the second embodiment and various examples thereof are presented may be adjusted arbitrarily without departing from the spirit of the present invention, and shall not be considered as limiting.

Referring to FIG. 7, a wireless communication method S2 including the CCFD communication may comprise the following steps of: providing at least one CCFD measurement report by at least one UE (step S201); and assigning, by a communication device, one of a symmetric CCFD communication mode, an asymmetric CCFD communication mode and a non-CCFD communication mode to each of the at least one UE according to the at least one CCFD measurement report (step S203). Any of the at least one UE that corresponds to the symmetric CCFD communication mode performs a symmetric CCFD communication with the communication device. Any two of the at least one UE that correspond to the asymmetric CCFD communication mode perform an asymmetric CCFD communication with the communication device. Any of the at least one UE that corresponds to the non-CCFD communication mode performs a non-CCFD communication with the communication device. The wireless communication method S2 may substantially be implemented on the wireless communication system of the first embodiment. Thus, the communication device and the UEs described in this embodiment may substantially correspond to the communication device 13 (or the communication devices 131 and 133) and the UEs 11a, 11b and 11c (or the UEs 111, 113, 115 and 117) respectively.

As an exemplary example of the second embodiment, in the wireless communication method S2, the at least one CCFD measurement report may comprise location information of the at least one UE, traffic information of the at least one UE, self-interference information of the at least one UE and mutual-interference information of the at least one UE.

As an exemplary example of the second embodiment, the wireless communication method S2 may further comprise the following steps of: assigning, by the communication device, resources to the symmetric CCFD communication mode, the asymmetric CCFD communication mode and the non-CCFD communication mode according to one of a frequency-division multiplexing technology and a time-division multiplexing technology.

As an exemplary example of the second embodiment, in the wireless communication method S2, the communication device may be one of a base station and a UE.

As an exemplary example of the second embodiment, in the wireless communication method S2, the step S201 further comprises the following step of: providing the at least one CCFD measurement report by the at least one UE to the communication device via a relay device. Additionally, in the wireless communication method S2, the step S203 further comprises the following step of: assigning, by the communication device, one of the symmetric CCFD communication mode, the asymmetric CCFD communication mode and the non-CCFD communication mode to each of the at least one UE via the relay device.

As an exemplary example of the second embodiment, the wireless communication method S2 may further comprise the following steps of: assigning by the communication device, one of an asymmetric CCFD downlink communication mode and an asymmetric CCFD uplink communication mode to each of the UEs corresponding to the asymmetric CCFD communication mode during a time interval according to the at least one CCFD measurement report; and choosing, by the communication device, at least one downlink UE from the UEs corresponding to the asymmetric CCFD downlink communication mode and at least one uplink UE from the UEs corresponding to the asymmetric CCFD uplink communication mode for each of the asymmetric CCFD communications to satisfy a communication requirement during the time interval. In this exemplary example, optionally, the at least one CCFD measurement report may comprise location information of the at least one UE, traffic information of the at least one UE, uplink and downlink requirement information of the at least one UE, and mutual-interference information of the at least one UE or the like. In this exemplary example, optionally, the wireless communication method S2 may further comprise the following step: if the communication request is not satisfied, then re-assigning, by the communication device, one of an asymmetric CCFD downlink communication mode and an asymmetric CCFD uplink communication mode to each of the UEs corresponding to the asymmetric CCFD communication mode. In this exemplary example, optionally, the communication requirement is associated with at least one of traffic symmetry and mutual-interference level. In this exemplary example, optionally, the at least one downlink UE and the at least one uplink UE may further perform another asymmetric CCFD communication with another communication device. In this exemplary example, optionally, the at least one downlink UE and the at least one uplink UE may further perform a D2D communication with at least one other UE.

The wireless communication method S2 substantially comprises steps corresponding to all operations of the wireless communication system 1. Since those of ordinary skill in the art can directly know all the corresponding steps comprised in the wireless communication method S2 according to the above description of the wireless communication system 1, these corresponding steps will not be further described herein.

According to the above descriptions, in the present invention, at least one UE of a wireless communication system may provide at least one CCFD measurement report to a communication device of the wireless communication system, and the communication device may assign a suitable communication mode to each of the at least one UE according to the at least one CCFD measurement report. Thus, the present invention can dynamically determine whether a UE is suitable for the CCFD communication and assign a suitable communication mode to the UE even in any of the following cases: the communication channel between the UE and a base station is changed, the communication channel between the UE and other UEs is changed, the ability of the UE itself to cancel or suppress the interference is changed, the mutual interference between the UE and the base station is changed, and the mutual interference between the UE and other UEs is changed or the like.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication system including co-time co-frequency full duplex (CCFD) communications, comprising:
at least one user equipment (UE), being configured to provide at least one CCFD measurement report; and
a communication device coupled with the at least one UE, being configured to assign one of a symmetric CCFD communication mode, an asymmetric CCFD communication mode and a non-CCFD communication mode to each of the at least one UE according to the at least one CCFD measurement report;
wherein any of the at least one UE that corresponds to the symmetric CCFD communication mode performs a symmetric CCFD communication with the communication device; any two of the at least one UE that correspond to the asymmetric CCFD communication mode perform an asymmetric CCFD communication with the communication device; and any of the at least one UE that corresponds to the non-CCFD communication mode performs a non-CCFD communication with the communication device.

2. The wireless communication system of claim 1, wherein the at least one CCFD measurement report comprises location information of the at least one UE, traffic information of the at least one UE, uplink and downlink requirement information of the at least one UE, self-interference information of the at least one UE and mutual-interference information of the at least one UE.

3. The wireless communication system of claim 1, wherein the communication device further assigns resources to the symmetric CCFD communication mode, the asymmetric CCFD communication mode and the non-CCFD communication mode according to one of a frequency-division multiplexing technology and a time-division multiplexing technology.

4. The wireless communication system of claim 1, wherein the communication device is one of a base station and a UE.

5. The wireless communication system of claim 1, further comprising a relay device, wherein the at least one UE provides the at least one CCFD measurement report to the communication device via the relay device; and the communication device assigns one of the symmetric CCFD communication mode, the asymmetric CCFD communication mode and the non-CCFD communication mode to each of the at least one UE via the relay device.

6. The wireless communication system of claim 1, wherein:
the communication device further assigns one of an asymmetric CCFD downlink communication mode and an asymmetric CCFD uplink communication mode to each of the UEs corresponding to the asymmetric CCFD communication mode during a time interval according to the at least one CCFD measurement report; and
the communication device further chooses at least one downlink UE from the UEs corresponding to the asymmetric CCFD downlink communication mode and chooses at least one uplink UE from the UEs corresponding to the asymmetric CCFD uplink communication mode for each of the asymmetric CCFD communications to satisfy a communication requirement during the time interval.

7. The wireless communication system of claim 6, wherein the at least one CCFD measurement report comprises location information of the at least one UE, traffic information of the at least one UE, uplink and downlink requirement information of the at least one UE, and mutual-interference information of the at least one UE.

8. The wireless communication system of claim 6, wherein if the communication requirement is not satisfied, the communication device re-assigns one of an asymmetric CCFD downlink communication mode and an asymmetric CCFD uplink communication mode to each of the UEs corresponding to the asymmetric CCFD communication mode.

9. The wireless communication system of claim 6, wherein the communication requirement is associated with at least one of traffic symmetry and mutual-interference level.

10. The wireless communication system of claim 6, wherein the at least one downlink UE and the at least one uplink UE further perform another asymmetric CCFD communication with another communication device.

11. The wireless communication system of claim 6, wherein the at least one downlink UE and the at least one uplink UE further perform a device-to-device (D2D) communication with at least one other UE.

12. A wireless communication method including co-time co-frequency full duplex (CCFD) communications, the method comprising:
providing at least one CCFD measurement report by at least one user equipment (UE); and
assigning, by a communication device, one of a symmetric CCFD communication mode, an asymmetric CCFD communication mode and a non-CCFD communication mode to each of the at least one UE according to the at least one CCFD measurement report;
wherein any of the at least one UE that corresponds to the symmetric CCFD communication mode performs a symmetric CCFD communication with the communication device; any two of the at least one UE that correspond to the asymmetric CCFD communication mode perform an asymmetric CCFD communication with the communication device; and any of the at least one UE that corresponds to the non-CCFD communication mode performs a non-CCFD communication with the communication device.

13. The wireless communication method of claim 12, wherein the at least one CCFD measurement report comprises location information of the at least one UE, traffic information of the at least one UE, uplink and downlink requirement information of the at least one UE, self-interference information of the at least one UE and mutual-interference information of the at least one UE.

14. The wireless communication method of claim 12, further comprising:
assigning, by the communication device, resources to the symmetric CCFD communication mode, the asymmetric CCFD communication mode and the non-CCFD communication mode according to one of a frequency-division multiplexing technology and a time-division multiplexing technology.

15. The wireless communication method of claim 12, wherein the communication device is one of a base station and a UE.

16. The wireless communication method of claim 12, wherein:
the step of providing the at least one CCFD measurement report further comprises:
providing the at least one CCFD measurement report by the at least one UE to the communication device via a relay device; and
the step of assigning a communication mode to each of the at least one UE further comprises:
assigning, by the communication device, one of the symmetric CCFD communication mode, the asymmetric CCFD communication mode and the non-CCFD communication mode to each of the at least one UE via the relay device.

17. The wireless communication method of claim 12, further comprising:
assigning by the communication device, one of an asymmetric CCFD downlink communication mode and an asymmetric CCFD uplink communication mode to each of the UEs corresponding to the asymmetric CCFD communication mode during a time interval according to the at least one CCFD measurement report; and
choosing, by the communication device, at least one downlink UE from the UEs corresponding to the asymmetric CCFD downlink communication mode and at least one uplink UE from the UEs corresponding to the asymmetric CCFD uplink communication mode for each of the asymmetric CCFD communications to satisfy a communication requirement during the time interval.

18. The wireless communication method of claim 17, wherein the at least one CCFD measurement report comprises location information of the at least one UE, traffic information of the at least one UE, uplink and downlink requirement information of the at least one UE, and mutual-interference information of the at least one UE.

19. The wireless communication method of claim 17, further comprising:
if the communication requirement is not satisfied, re-assigning, by the communication device, one of an asymmetric CCFD downlink communication mode and an asymmetric CCFD uplink communication mode to each of the UEs corresponding to the asymmetric CCFD communication mode.

20. The wireless communication method of claim 17, wherein the communication requirement is associated with at least one of traffic symmetry and mutual-interference level.

21. The wireless communication method of claim 17, wherein the at least one downlink UE and the at least one uplink UE further perform another asymmetric CCFD communication with another communication device.

22. The wireless communication method of claim 17, wherein the at least one downlink UE and the at least one uplink UE further perform a device-to-device (D2D) communication with at least one other UE.
